(19) United States
(12) Patent Application Publication
(10) Pub. No.: US 2026/0092876 A1
(43) Pub. Date: Apr. 2, 2026

(54) METHOD FOR AUTOMATED INSPECTION OF THE SURFACE OF A SOLID OBJECT AND SYSTEM CONFIGURED TO EXECUTE THE METHOD

(71) Applicant: AIRBUS OPERATIONS SAS, Toulouse (FR)

(72) Inventors: Henri MARTICOU, Toulouse (FR); Raphaël VIARDS, Toulouse (FR)

(73) Assignee: AIRBUS OPERATIONS SAS, Toulouse (FR)

(21) Appl. No.: 19/337,652

(22) Filed: Sep. 23, 2025

(30) Foreign Application Priority Data
Sep. 30, 2024 (FR) 2410464

(51) Int. Cl. G01N 21/88; G01B 11/24; G01N 21/95

(52) U.S. Cl. CPC G01N 21/8851; G01B 11/24; G01N 21/95; G01N 2021/8887

(57) ABSTRACT

A method for automatically inspecting a surface of a solid object such as, for example, a surface of an aircraft; the method using a step of blurring said surface represented in the form of a depth map image, followed by three successive derivation operations applied to said image. The invention also relates to a system configured to perform the method. Advantageously, it is thus possible to automatically detect planarity defects in a surface of an aircraft with a level of accuracy not yet achieved.

### TECHNICAL FIELD

The present invention relates to an improved method for automated inspection of an object surface, such as, for example, an aircraft component surface, based on information obtained from a surface inspection device, as well as a system configured to perform such a method.

### PREVIOUS PRIOR ART

Automated inspection and quality control methods used in industry often result in significant time savings in product manufacturing stages. This is particularly advantageous for equipment of which the manufacture requires a large number of components and manufacturing stages, for which an increase in production rate is often sought. The inspection of aircraft surfaces during manufacturing or maintenance operations is commonplace, and there is a need for automated means of inspecting and detecting possible surface defects, providing a level of perception and detection at least as high as that of the human eye, if not higher, in order to detect very small surface defects during manufacturing or maintenance operations. Surface inspection is also used during scheduled recurring maintenance operations.

The situation can be improved.

### DESCRIPTION OF THE INVENTION

One object of the present invention is to provide means for the automated inspection of object surfaces, for example aircraft surfaces, capable of detecting surface defects with a depth of up to one third of the resolution of the surface inspection device (or acquisition system) used, depending on the case.

To this end, a method is proposed for the automated inspection of the condition of a solid surface, said method comprising:
obtaining first information, representative of the shape of a surface of a solid object, in the form of a map of distances between said surface and a sensor of a distance measuring device,
obtaining second information by applying a blurring filter to said first information,
obtaining third information by a first derivation operation of said second information, using a first derivation operator,
obtaining fourth information by a second derivation operation of the third information, using a second derivation operator,
and the method further comprising:
obtaining fifth information by a third derivation operation of the fourth information, using a third derivation operator, then,
detecting a defect in said surface, using a defect detection module, based on the fifth information obtained.

The method according to the invention may further comprise the following optional features, considered alone or in combination:
The automated inspection method further comprises a step of notifying the presence of a defect detected in a surface.
The automated inspection method is included in a method for manufacturing an aircraft component, which manufacturing method further comprises a step of modifying a surface based on at least one piece of information representative of a defect detected by the automated inspection method.
The blurring filter used by the method is determined from at least one characteristic of the distance measurement device (sensor) used to obtain the first information.
The derivation operators used by the inspection method are such that:
said first derivation operator is a gradient-type operator, the second derivation operator is a Hessian matrix-type operator, and the third derivation operator is a non-planarity gradient-type operator.

Another object of the invention is an automated inspection system for inspecting the condition of a surface of a solid object, the system comprising electronic circuitry configured to:
obtain first information, representative of the shape of a surface of a solid object, in the form of a map of distances between said surface and a sensor of a distance measuring device,
obtain second information by applying a blurring filter to said first information,
obtain third information by a derivation operation of said second information, using a first derivation operator,
obtain fourth information by a second derivation operation of the third information, using a second derivation operator,
and the method further comprising:
obtaining fifth information by a third derivation operation of the fourth information, using a third derivation operator, then,
detecting a defect in said surface, using a defect detection module, based on the fifth information obtained.

The system according to the invention may further have the following optional features, considered alone or in combination:
The automated surface condition inspection system further comprises electronic circuitry configured to perform a step of notifying the presence of a defect detected in a surface.
The automated inspection system is included in an aircraft component manufacturing system further comprising means for performing a step of modifying a surface based on at least one piece of information representative of a defect in that surface.
At least one characteristic of the blurring filter used by the automated inspection system is determined from at least one characteristic of the distance measuring device used to obtain the first information.
The derivation operators used by the inspection system are such that:
said first derivation operator is a gradient-type operator, the second derivation operator is a Hessian matrix-type operator, and the third derivation operator is a non-planarity gradient-type operator.

Another object of the invention is a computer program product comprising program code instructions for executing steps of a method as previously described when said instructions are executed by a processor of an automated inspection system for a surface of a solid object.

Finally, the invention relates to a storage device comprising a computer program product as described above.

### BRIEF DESCRIPTION OF THE DRAWINGS

FIG. 1 schematically illustrates an automated inspection system for inspecting the condition of a surface of a solid object according to one embodiment;

FIG. 2 schematically illustrates an aircraft with surfaces that can be inspected using the system shown in FIG. 1;

FIG. 3 is a schematic representation of a set of information representative of the surface of a solid object and taking the form of a depth (or distance) map image used as input data for the automated inspection system already shown in FIG. 1;

FIG. 4 is a flowchart illustrating the steps of an automated inspection method for inspecting the condition of a surface of a solid object, performed in the automated inspection system already shown in FIG. 1, according to one embodiment;

FIG. 5 illustrates details of an overall derivation step of the method described in relation to FIG. 4; and

FIG. 6 is a diagram illustrating an example of the architecture of a data processing unit comprising electronic circuitry configured to execute the method described in relation to FIG. 4, according to one embodiment.

### DETAILED DESCRIPTION OF EMBODIMENTS

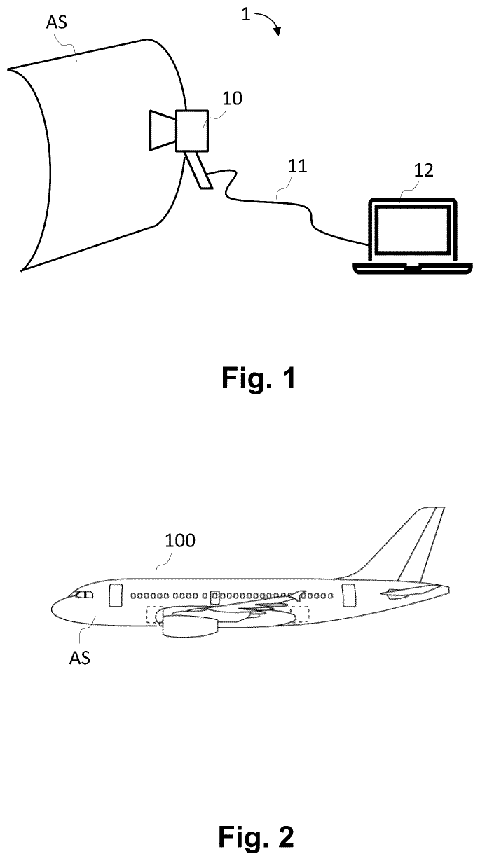

FIG. 1 represents an automated inspection system 1 for inspecting the condition of a surface AS of a solid object according to one embodiment. The automated inspection system 1 comprises a sensor device 10 connected to a processing unit 12 via a communication link 11. According to one embodiment, the communication link 11 is wired. According to a variant, the communication link 11 is configured to operate wirelessly. According to one embodiment, the sensor device 10 is a camera or scanner operating as a distance sensor configured to deliver a set of “3D point cloud” data, which data is then representative of the inspected surface AS, or more precisely of the surface condition of the inspected surface AS. The distance sensor device 10 measures distances between a reference point that it includes and a plurality of points on the surface of a solid object. According to one embodiment, each of the points in the 3D point cloud is instantiated in the form of a pair of x and y coordinates considered in combination with a distance value S (x,y) relative to the camera positioned with reference to the normal to the plane tangent to the inspected surface AS in the measurement field of the sensor 10 (camera or scanner, for example). For each inspected area of the surface AS, a 3D point cloud S (x, y) can be transmitted by the sensor device 10 to the processing unit 12 via the communication link 11. This 3D point cloud S (x, y) constitutes initial information representative of the shape of the inspected surface AS (hereinafter also referred to as the “surface condition” of the inspected surface AS). In other words, this 3D cloud of points S (x, y) constitutes a depth map determining a set of distances for points on the surface AS observed and inspected within the measurement field of the sensor device 10. The processing unit 12 is configured to perform successive processing operations on this initial information in order to detect and, if necessary, characterize surface defects present in the inspected surface AS, such as indentations and protrusions of various shapes and sizes (impacts, scratches, embossing, hollows, etc.).

FIG. 2 illustrates an example of an inspected surface AS of an aircraft 100. According to the example described in relation to FIG. 2, the surface AS is a surface of a fuselage element of the aircraft 100. Obviously, this example is not limiting and the automated inspection system 1 can be useful for inspecting many surfaces of an aircraft, including in particular the fuselage and the wing.

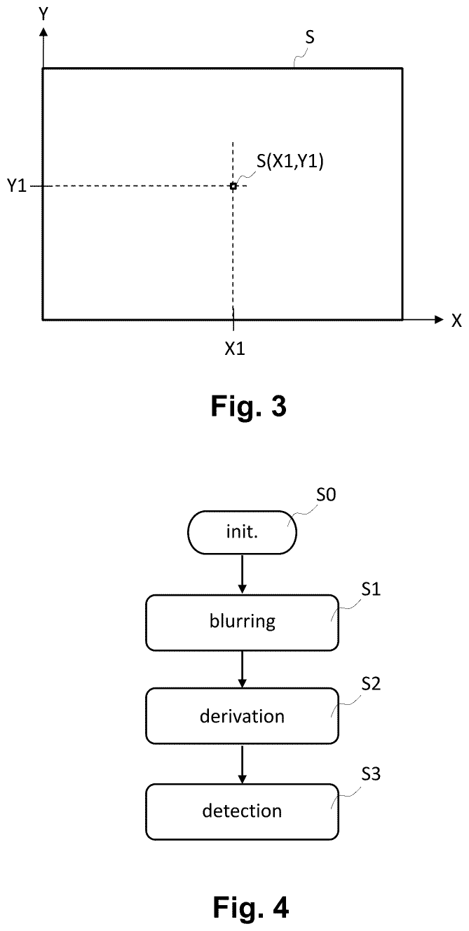

FIG. 3 schematically illustrates a data structure comprising the aforementioned first information, stored in the form of a matrix S of values, of which each of the elements S (X, Y) is determined and stored with reference to the X and Y coordinates of a plane. For example, an element S (X1, Y1) represents the distance between the sensor device 10 and a point on the surface AS of which the position is determined in space by the coordinates X1 and Y1. According to one embodiment, the matrix of values S also constitutes an image of the distances measured for the different points of the matrix S. For example, the brighter a point in the image, the greater the distance between the corresponding point on the inspected surface AS and the distance measurement sensor of the sensor device 10, or vice versa. The terms “corresponding point on the inspected surface” refer here to a point on the inspected surface AS that is represented by a given point in the image (or matrix) S. Thus, the structuring of the initial information obtained constitutes a 3D to 2D transformation of the inspected surface AS into an image S which can be processed by the processing unit 12 for the purpose of detecting the presence of any defects in the inspected surface AS.

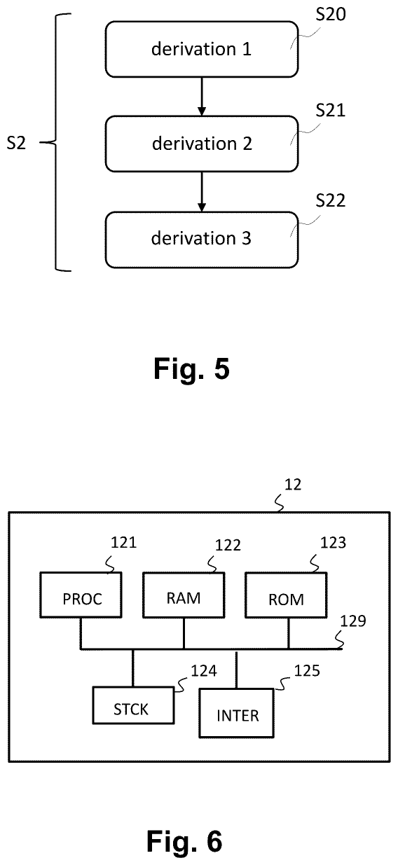

FIG. 4 describes the steps of an automated inspection method performed by and within the automated inspection system 1, according to one embodiment of the invention. Step S0 is an initial (or initialization) step at the end of which all the circuits and components of the automated inspection system 1 are powered up, normally supplied with energy, configured and operational. In particular, the sensor device 10 is positioned on a support or by an operator facing an area of the inspected surface AS, and initial information representative of the surface condition of the inspected surface AS is transmitted by the sensor device 10 to the processing unit 12. In step S1, a blurring operation is performed on the matrix (or image) S, which is instantiated by the initial information obtained by the processing unit 12. According to one embodiment, the blurring operation performs blurring of sufficient size to smooth the surface of the solid object and the noise of the measuring tool, but without removing the defects being sought (for example, a Gaussian blur with a sigma of 2 mm). The matrix or image resulting from this blurring constitutes new information, representative of the surface AS, in the form of a blurred image matrix. Next, step S2 consists of cleverly performing a triple derivation of the blurred image matrix applied to the information obtained from the blurring. The term “triple derivation” here refers to three successive derivation operations applied to the image matrix representative of the inspected surface AS (or an area or portion of this surface), using three different derivation operators in a clever manner. The details of these operators are described further in this description, in relation to FIG. 5. Finally, detection of one or more possible defects present in the inspected surface AS is performed in a step S3, using a defect detection module. According to one embodiment, the defect detection module is implemented by the processing unit 12. According to one embodiment, the defect detection module is based on a conventional segmentation approach that can use a blob detection algorithm, such as a Gaussian difference filter, or a partitioning method such as the k-means algorithm, or a watershed algorithm. According to another embodiment, the defect detection module is a neural network (NN) trained to perform segmentation and/or classification tasks. For example, this may be the “YOLO” (You Only Look Once) algorithm or an algorithm from the ResNet (Residual Networks) family, capable of performing detection and classification simultaneously, or the U-Net segmentation algorithm.

The selected detection algorithm operates on the image matrix resulting from the three successive derivations after blurring and provides information enabling the identification and locating of any surface defects. According to one embodiment, this highlighting is achieved by instantiating bounding boxes, each associated with a probability of a defect being present in the area delimited by the bounding box of the image matrix resulting from the three derivations. It is then possible, during a notification step S4 (not shown in FIG. 4), subsequent to step S3, to deliver, where applicable, location information for one or more possible defects detected in the inspected AS surface, in order to control or organize changes to the manufacturing method and/or maintenance operations.

FIG. 5 provides details of step S2 of derivation according to a non-limiting embodiment.

According to this embodiment, step S2 comprises three successive derivation operations using three derivation operators respectively.

A first step S20 (first sub-step of S2), subsequent to step S1, calculates the gradient of the inspected surface, which is expressed as:

$$∇ s ( x , y ) = [ \frac{\frac{\partial s}{\partial x}}{\frac{\partial s}{\partial y}} ] = [ \frac{{s}_{x}}{{s}_{y}} ]$$

where S (x, y) is the blurred image matrix obtained at the end of blurring step S1.

Indeed, the first-order differential operator for a surface is the gradient. It allows to determine, at each point on the surface, a vector quantity defining the direction and magnitude of the steepest slope at a given point on the surface.

A two-dimensional representation of the surface is thus obtained in the form of a scalar field corresponding to the norm of the gradient. This representation advantageously provides information on the slope inclination at each point of the analyzed surface.

A second step S21 (second sub-step of S2), subsequent to step S20, performs a Hessian matrix calculation, which is expressed as:

$$H ( x , y ) = [ \begin{matrix}{s}_{xx} & {s}_{xy} \\ {s}_{yx} & {s}_{yy}\end{matrix} ]$$

$$where$$

$${s}_{xx} = \frac{{\partial }^{2} S ( x , y )}{\partial {x}^{2}} ; {s}_{xy} = \frac{{\partial }^{2} S ( x , y )}{\partial x \partial y} ; {s}_{yx} = \frac{{\partial }^{2} S ( x , y )}{\partial y \partial x} ; and {s}_{yy} = \frac{{\partial }^{2} S ( x , y )}{\partial {y}^{2}} ,$$

allowing local variations in planarity to be determined:

$$σ ( x , y ) = {S}_{xx}^{2} + {S}_{xy}^{2}$$

The Hessian matrix, also known as the second derivative matrix, is the equivalent of the gradient in second-order differential geometry. It is a matrix quantity that provides information about the curvature of the surface at each point on the analyzed surface.

### With Regard to the Eigenvalues of the Hessian Matrix:

The eigenvalues of H are called principal curvatures and correspond to the strength of the curvature in the principal directions. Invariant under rotation, they are real values, denoted κ₁ and κ₂ such that κ₁≥κ₂.

These eigenvalues of H are calculated as follows:

$$κ = \frac{( {S}_{xx} + {S}_{yy} ) \pm \sqrt{4 {S}_{xy}^{2} + {( {S}_{xx} - {S}_{yy} )}^{2}}}{2}$$

where K is K₁ or K₂ depending on the operator + or −

### With Regard to the Principal Directions or Second-Order Gauge Coordinates:

The eigenvectors of H are called principal directions and correspond to the directions of the principal curvatures, which are always orthogonal.

These principal directions are called gauge coordinates p and q, such that p corresponds to the direction of greatest curvature and q to the direction of least curvature.

These principal directions are calculated as follows:

$$p = u / ‖ u ‖ and q = v / ‖ v ‖$$

$$where u = \{ 1 , \frac{{κ}_{1} - {S}_{xx}}{{S}_{xy}} \} and where v = \{ 1 , \frac{{κ}_{2} - {S}_{xx}}{{S}_{xy}} \}$$

Partial derivatives according to the second-order gauge coordinates can then be determined and used.

Depending on the variants, several two-dimensional projections of the Hessian matrix can be obtained and used in the form of a scalar field. Note that, in this context, by definition,

$${s}_{pp} = \frac{{\partial }^{2} S}{\partial {p}^{2}} = {K}_{1} and {s}_{qq} = \frac{{\partial }^{2} S}{\partial {q}^{2}} = {K}_{2}$$

According to one embodiment, a Gaussian curvature projection G is determined from the Hessian matrix, corresponding to the determinant of the Hessian matrix and providing an intrinsic measure of the curvature at each point on the surface:

$$G = {S}_{pp} \cdot {S}_{qq} = {κ}_{1} \cdot {κ}_{2} = det ( H )$$

According to one embodiment, a mean curvature projection HM is determined from the Hessian matrix, corresponding to the mean of the principal curvatures or eigenvalues of the Hessian matrix, expressing at each point the mean curvature of the surface at that point:

$$HM = \frac{{S}_{pp} + {S}_{qq}}{2} = \frac{{κ}_{1} + {κ}_{2}}{2}$$

According to one embodiment, a Laplacian-type projection is determined from the Hessian matrix, corresponding to the trace of the Hessian matrix, which can also be calculated directly as the divergence of the gradient, which also provides information on the local curvature at each point:

$$Δ S ( x , y ) = {∇}^{2} S ( x , y ) = div ( ∇ S ( x , y ) ) = trace ( H ) = {S}_{xx} + {S}_{yy}$$

According to one embodiment, a planarity deviation projection σ is determined from the Hessian matrix, corresponding to the sum of the squares of the principal curvatures or eigenvalues of the Hessian matrix, expressing at each point of the surface its local “degree of non-planarity”:

$$σ = {S}_{pp}^{2} + {S}_{qq}^{2} = {κ}_{1}^{2} + {κ}_{2}^{2}$$

According to one embodiment, a projection based on the degree of curvature C is determined from the Hessian matrix, corresponding to the square root of the planarity deviation:

$$C = \sqrt{{S}_{pp}^{2} + {S}_{qq}^{2}} = \sqrt{{κ}_{1}^{2} + {κ}_{2}^{2}}$$

According to one embodiment, a projection based on shape angle F is determined from the Hessian matrix, corresponding to the arc tangent of the ratio of the principal curvatures, and providing information on the local shape of the surface at each point:

$$F = {tan}^{- 1} ( \frac{{S}_{qq}}{{S}_{pp}} ) = {tan}^{- 1} ( \frac{{κ}_{2}}{{κ}_{1}} )$$

Finally, a third step S22 (third sub-step of S2), following step S21, performs a so-called “third-order” derivation, using a new operator defining a previously determined local rate of variation in planarity, such as to highlight defects, including those of very small dimensions, by inserting the resulting information into a module for detecting possible defects during step S3, following step S22:

$$∇ σ ( x , y ) = 2 \cdot [ \begin{matrix}{s}_{xx} \cdot {s}_{xxx} + {s}_{yy} \cdot {s}_{yyx} \\ {s}_{xx} \cdot {s}_{xxy} + {s}_{yy} \cdot {s}_{yyy}\end{matrix} ]$$

There is no third-order differential operator that can be expressed in a trivial form. According to one embodiment, it is proposed to apply the first-order derivation operator (gradient) to one of the scalar fields obtained by second-order derivation (e.g. calculation of the gradient of planarity deviations).

A two-dimensional representation is then obtained in the form of a scalar field corresponding to the norm of said gradient. This representation provides information on the rate of change of the curvature or planarity of the surface at each of its points.

According to some variants, it is possible to perform many other combinations to obtain third-order differential information (e.g. applying the gradient operator and then calculating the associated scalar field three times in succession, calculating the Hessian of the scalar field obtained after the first derivation, etc.). These variants all advantageously allow information related to a rate of change in surface curvature to be highlighted.

FIG. 6 schematically illustrates an example of the internal architecture of the processing unit 12 of the automated inspection system 1, configured to execute the method described above.

According to the example of hardware architecture shown in FIG. 6, the processing unit 12 comprises, connected by a communication bus 129: a processor or CPU (Central Processing Unit) 121; a RAM (Random Access Memory) 122; a read-only memory (ROM) 123; a storage unit such as a hard disk (or a storage media reader, such as a Secure Digital (SD) card reader) 124; a communication interface module 125 enabling the processing unit 12 to communicate with remote devices, such as the sensor device 10 configured to perform surface analyses by measuring distances, or other remote equipment, for example equipment at an aircraft production site or an aircraft maintenance site.

The processor 121 of the processing unit 12 is capable of executing instructions loaded into the RAM 122 from the ROM 123, an external memory (not shown), a storage medium (such as an SD card), or a communication network. When the processing unit 12 is powered up, the processor 121 is capable of reading instructions from the RAM 122 and executing them. These instructions form a computer program causing the processor 121 of the processing unit 12 to implement all or part of an automated inspection method as previously described.

All or part of such an automated surface inspection method, for example for inspecting aircraft surfaces, can then be implemented in software form by executing a set of instructions by a programmable machine, such as a DSP (Digital Signal Processor) or a microcontroller, or implemented in hardware form by a dedicated machine or component, such as an FPGA (Field-Programmable Gate Array) or an ASIC (Application-Specific Integrated Circuit). In general, the processing unit 12 comprises electronic circuitry configured to implement an automated inspection method for solid object surfaces. Of course, the processing unit 12 also comprises all the elements usually present in a system comprising a control unit and its peripherals, such as a power supply circuit, a power supply supervision circuit, one or more clock circuits, a reset circuit, input/output ports, interrupt inputs, bus drivers, this list being non-exhaustive.

1. A method for automatically inspecting the condition of a surface of a solid object, said method comprising:
obtaining first information, representative of the shape of the surface of the solid object, in the form of a map of distances between said surface and a sensor of a measuring device,
obtaining second information by applying a blurring filter to said first information,
obtaining third information by a first derivation operation of said second information, using a first derivation operator,
obtaining fourth information by a second derivation operation of the third information, using a second derivation operator,
and said method further comprises:
obtaining fifth information by a third derivation operation of the fourth information, using a third derivation operator, then,
detecting a defect in said surface using a defect detection module based on the fifth information obtained.

2. The automated inspection method according to claim 1, further comprising a step of notifying the presence of said defect detected in said surface.

3. The method for manufacturing an aircraft component comprising an automated inspection method according to claim 2 and a step of modifying said surface based on at least one piece of information representative of said defect.

4. The method according to claim 1, wherein said blurring filter is determined from at least one characteristic of said distance measuring device.

5. The method according to claim 1, wherein:
said first derivation operator is a gradient-type operator,
said second derivation operator is a Hessian matrix type operator, and,
said third derivation operator is a non-planarity gradient type operator.

6. An automated inspection system for inspecting the condition of a surface of a solid object, said system comprising electronic circuitry configured to:
obtain first information, representative of the shape of a surface of a solid object, in the form of a map of distances between said surface and a sensor of a measuring device,
obtain second information by applying a blurring filter to said first information,
obtain third information by a derivation operation of said second information, using a first derivation operator,
obtain fourth information by a second derivation operation of the third information, using a second derivation operator,
obtain fifth information by a third derivation operation of the fourth information, using a third derivation operator, and,
detect a defect in said surface, using a defect detection module, from the fifth information obtained.

7. The automated inspection system for inspecting the condition of a surface according to claim 6, further comprising electronic circuitry configured to perform a notification step of the presence of said defect detected in said surface.

8. A system for manufacturing an aircraft component comprising an automated inspection system according to claim 7 and means for performing a step of modifying said surface based on at least one piece of information representative of said defect.

9. The system according to claim 6, wherein said blurring filter is determined from at least one characteristic of said distance measuring device.

10. (canceled)

11. A non-transitory storage device embodying a computer program instructions for executing steps of the method according to claim 1 when said instructions are executed by a processor of an automated inspection system for a surface of a solid object.
